(19) United States
(12) Patent Application Publication
(10) Pub. No.: US 2004/0235384 A1
(43) Pub. Date: Nov. 25, 2004

(54) Method and system for programming controllers and control assemblies

(75) Inventors: Daniel Reich, Tucson, AZ (US); Vladi Reich, Tucson, AZ (US); Boris Kaplinsky, Sierra Madre, CA (US); Kiril Zuykov, Moscow rigion (RU); Aleksey Login, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(73) Assignee: Arecont Intellectual Property Holdings, L.L.C.

(21) Appl. No.: 10/440,765

(22) Filed: May 19, 2003

(51) Int. Cl. H01J 9/00

(52) U.S. Cl. 445/24

(57) ABSTRACT

In a Graphical Programming System, Users may develop algorithmic programs for Controllers or Controller Assemblies utilizes Programming Tools located on a Central Server. Users access the Central Server utilizing a Client connected by the Internet, an Intranet, or a Local Area Network (“LAN”). A programming Project resides on the Central Server but is displayed on the Client, allowing the User to modify the project from the Client. Actions are transmitted as XML, or similar, files which are processed by the Programming Tools. Multiple Users may access the Project simultaneously and a Project may be temporarily interrupted, only to be re-initiated from any Client connected to the Central Server. Additionally, the Graphical Programming System may be utilized to simulate real-world processes. Once a Project is completed, respective machine code may be transmitted to Controllers or Controller Assemblies connected to the Central Server.

### BACKGROUND OF THE INVENTION

1. Field of the Invention

This invention is related in general to the field of microprocessor based controllers and Distributed Control Systems. In particular, a Central Computer holds programming interfaces and libraries which can be accessed by clients utilizing an Internet, Intranet, or local area network (“LAN”) to graphically create executable software files for controllers or control assemblies.

2. Description of the Prior Art

It is very common to use electro-mechanical devices to control any of a myriad of different types of equipment. For example, relays are used to close doors, motor drivers are used to turn fans, and photoelectric switches are used to turn on street-lamps. These electromechanical devices, referred to as controllers, often can be quite sophisticated and capable of performing advanced algorithmic operations. For example, heating, ventilation and air conditioning (HVAC) controllers often possess microprocessors used to analyze and respond to their environment such as changes in temperature, pressure, and humidity. These HVAC controllers can even implement efficient heating and cooling plans in response to anticipated weather patterns.

Controllers have operating parameters that control their behavior. For example, a variable-speed exhaust fan may be connected to a controller which is set to activate the fan when the ambient air temperature exceeds 90 degrees and linearly increase the fan speed as the temperature increases until the fan has reached its maximum rate of revolution. Additional parameters may be designated as triggers for messages or alarms. For example, if the ambient air temperature of a designated area exceeds a predetermined parameter or the exhaust fan is spinning at an unacceptable rate, a message or alarm may be generated. A computer is sometimes connected to a controller to program its parameters, direct its behavior, and retrieve and display its status information, messages, and alarms.

Controllers can work singly or in clusters. If more than one controller is required, a master controller can be designated to coordinate the efforts of the others, forming a controller assembly. Alternatively, controller assemblies may be formed by multiple peer-to-peer controllers. Controllers or controller assemblies may be distributed throughout large industrial or commercial buildings, or may be separated by large geographical distances. Controllers may be connected using either wired networks or wireless communications networks such as that embodied by IEEE standard 803.3 or 802.11 or, may utilize telecommunications systems such as modems, DSL, cable, and satellite systems.

With the advent of the Internet, it has become possible to connect controllers together using the World Wide Web (“WWW”). The Internet is a layered network communication system governed by the Open Systems Interconnection (“OSI”) model. Messages are sent over the Internet using transmission protocols such as Transmission Control Protocol/Internet Protocol (TCP/IP) or User Datagram Protocol/Internet Protocol (UDP/IP). Web browsers are utilized to convert messages into a human readable format. Once a controller has been connected to either the Internet, an Intranet, or a local area network (“LAN”), it is a straightforward matter to provide access to the controller from other computers located in a location other than that of the controller.

When the first microprocessor based controllers emerged, they were programmed in machine code. However, assembly languages where developed which simplified the programming tasks. Eventually, high-level structured languages such as Fortran, basic, “C”, etc. and compilers were developed to translate text programming code into machine code. This type of programming, called text-based programming, requires high level programming skills as well as knowledge of the target technology.

The desire to simplify the programming task and make programming more efficient led to development of object-oriented graphical methods of programming. The most prominent methods in this group are Ladder Logic and Functional Block Diagrams. In both of these methods, programming objects are represented by graphical images (“icons”) on a computer monitor's display. Utilizing Ladder Logic, these images are traditional images representative of relay contacts and coils. In Functional Block Diagram programming, the images are generic boxes with inputs and outputs. In both cases, programming is done by selecting different graphical objects, placing them in a work area, and connecting them with lines representing electrical connections or information flow. These methods are described in International Standard IEC 1131-3. The advantage of graphical programming methods is that they require only limited programming skills. This allows programmers to concentrate on arranging technological tasks.

In object oriented graphical programming, function blocks are utilized to implement algorithms. A function block can provide a software solution to a small problem, such as controlling a single valve, or may represent the control of a major activity, such as the operation of a complete production line. Function blocks allow industrial algorithms to be encapsulated in a form that can be readily understood and applied by people who are not software specialists. Each block has a defined set of input parameters, which are read by the internal algorithm when it is executed. Results of the algorithm are written to the functional block's outputs. Entire applications can be built from networks of function blocks formed by interconnecting functional block inputs with the outputs of other functional blocks.

The computer software necessary for implementing graphical programming usually includes: (1) a Graphical language translator, and (2) a text-based language compiler. The language translator converts graphical language activities into a text-based language, such as “C” or Fortran. The text-based language compiler accepts the text-based language instructions and generates machine code statements which can be used to direct the activity of controllers. Each language compiler is generally developed for a specific type of computer processor.

These software tools are usually expensive and, therefore, are generally used by someone wishing to program a large number of the same type of processors or controllers. If a user wants to program a single piece of equipment, it is difficult to justify buying these graphical programming software tools, which often cost more than the controllers themselves. In this case, the user usually creates a software program using the more difficult text-based programming languages.

Therefore, it is desirable to provide a means for affordable graphical programming which may be utilized by anyone with basic programming skills. It is further desirable to provide access to graphical programming tools through the Internet, Intranet, or LAN utilizing a standard Internet browser.

### SUMMARY OF THE INVENTION

This invention is based on utilizing a Central Server for holding expensive graphical programming tools. Access to these graphical programs is provided through a network connection over the Internet, Intranet, or Local Area Network (“LAN”). A User may access the network through a Client, either a personal computer or a personal digital assistant (“PDA”) equipped with an Internet browser.

When users wish to program an algorithm for a controller, they access the Central Server and request that a Project be created. The Project is created at and resides on the Central Server. However, files representative of the current state of the Project are created on a regular basis and transmitted to the User, where they are displayed on the Client. Requests by the user are likewise packaged and transmitted to the Central Server, where they are implemented in the Project. In this manner, a user may appear to be utilizing a graphical programming tool on his Client to create a controller program, while, in fact, all the activity occurs at the Central Server. Multiple Users may have access to the graphical programming tools, reducing the per user cost of the software.

One aspect of this invention is a means for locating expensive graphical programming tools on a Central Server. Access to these tools is provided through an Internet browser over a network connection.

Another aspect of this invention is to provide a means utilizing graphical programming tools on a Central Server to create programs for controllers or control assemblies. Program construction and compilation actually occurs at the Central Server.

Yet another aspect of this invention is to provide a means of transmitting image files from an active graphical program on a Central Server to a User. These images are displayed on the Client.

Still another aspect of the invention is to provide a means of transmitting requests from the User to the Client Server. These requests are utilized to effect changes to a project or algorithm being constructed by the graphical programming tools.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is an illustration providing an overview of a Graphical Programming System, including a Client, a Central Server, a Network, and an optional Controller, according to the invention.

FIG. 2 is a block diagram illustrating the four primary functions of the Cental Server, according to the invention.

FIG. 3 is a block diagram illustrating the structural elements of the Central Server, including memory and algorithmic constructs, according to the invention.

FIG. 4 is an illustration indicating the components of an algorithmic Object, according to the invention.

FIG. 5 is a block diagram illustrating the Programming Interface, and its associated Active Programming Field and Library of Objects, according to the invention.

FIG. 6 is a block diagram demonstrating the construction of a Controller algorithm utilizing Icons and Traces, according to the invention.

FIG. 7 is an illustration presenting a Dialog Box and representative Object Properties, according to the invention.

### DESCRIPTION OF THE PREFERRED EMBODIMENTS

Structure

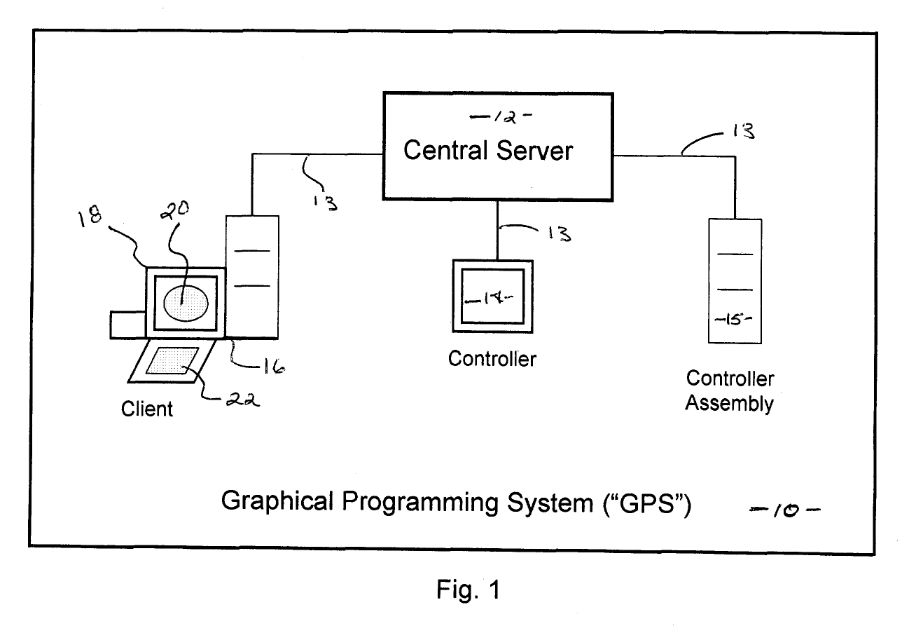

As a general overview of the invention, FIG. 1 shows a Graphical Programming System (“GPS”) 10, including a Central Server 12, a Communications Network (“Network”) 13, an optional Controller 14 or Controller Assembly 15 and one or more Clients 16. In the preferred embodiment of the invention, the Network may be the Internet, an Intranet, or a Local Area Network (“LAN”), or any combination of these. Additionally, Clients may include personal computers (“PCs”), personal digital assistants (“PDAs”), or other computing devices which include a Display 18, an Internet Browser (“Browser”) 20, and a User Interface 22.

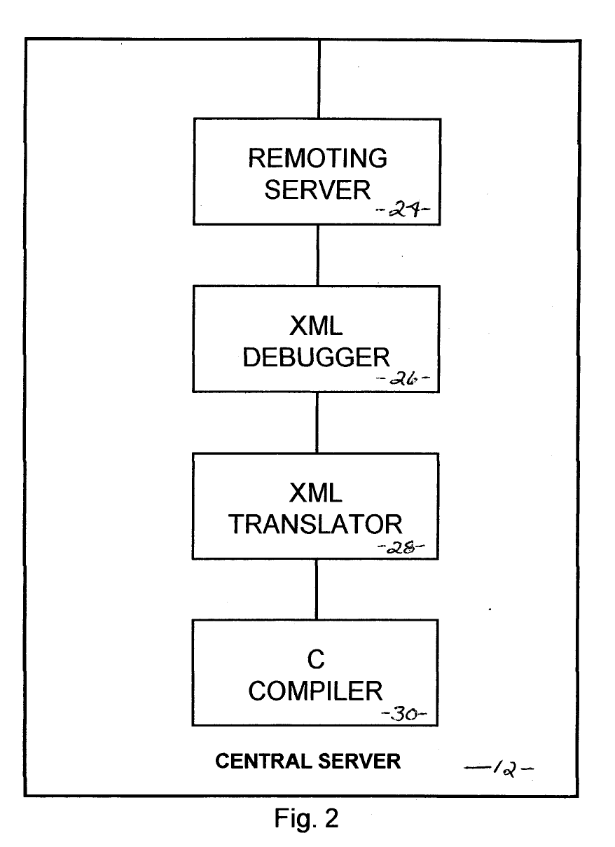

FIG. 2 illustrates the functional elements of the Graphical Programming System 10 residing in memory in the Central Server 12. The Remoting Server 24 is responsible for establishing and maintaining a communications channel with the Client 16. The XML Debugger (“Debugger”) 26 monitors instructions arriving from the Client 16 to determine whether the requested activity is valid. The XML Translater (“Translater”) 28 converts XML files arriving from the Client 16 into “C” code instructions. The C Compiler (“Compiler”) 30 generates machine code directed at type-specific processors inherent in Controllers 14 or Controller Assemblies 15.

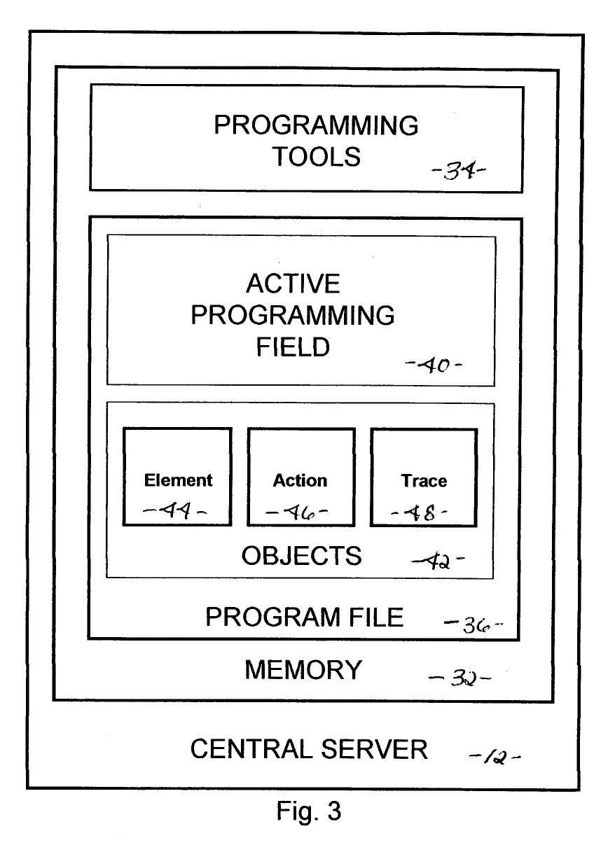

FIG. 3 illustrates the structural elements of the Graphical Programming System 10 residing in the Central Server 12, according to the preferred embodiment of the invention. A Memory 32 holds the Graphical Programming Tools (“Programming Tools”) 34 and Program File 36. The Programming Tools 34 are computer software programs used to graphically construct a Controller Algorithm. The Controller Algorithm is the set of instructions which described the desired behavior of a target controller or controller assembly.

The Program File 36 encapsulates the Algorithmic Project (“Project”). Each Project includes an Active Programming Field (“APF”) 40 and associated Objects 42, representing Elements 44, Actions 46, or Traces 48. Each Object performs a logical or computational task.

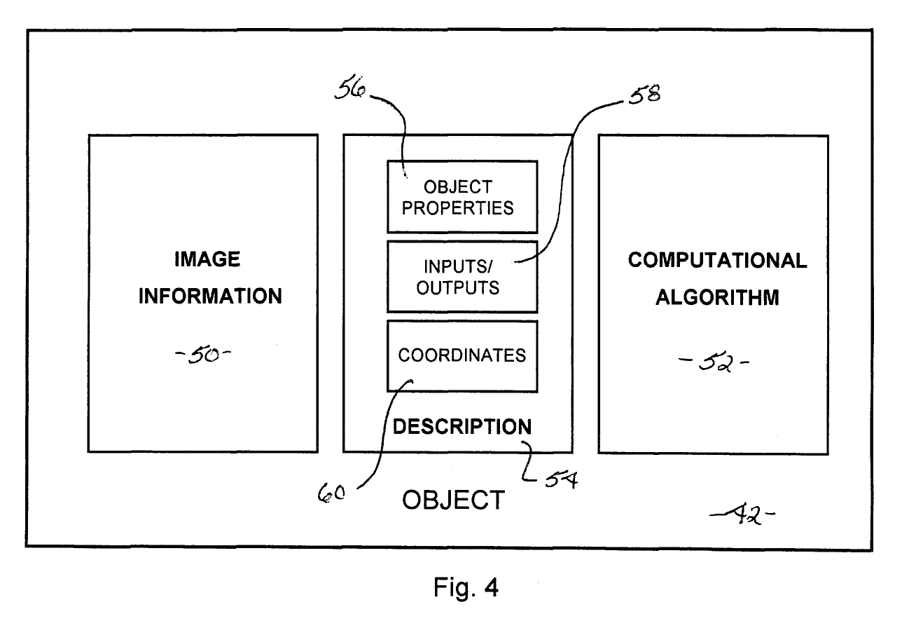

The block diagram of FIG. 4 illustrates the components of each Object 42. Image Information 50 identifies the graphical representation of the object, as it is represented on a Display 18 as an icon. This graphical representation may be any geometric shape, such as a circle or polygon. The logical functionality of the Object 42 is determined by its Computational Algorithm 52. This functionality may be representative of a control system element, such as a heater or fan, or may represent control functionality, such as response to a change in temperature or pressure.

The Description 54 identifies the Object Properties 56, its Inputs/Outputs 58, and its Coordinates 60. The Coordinates identify the relative position of the icon representing the Object 42 on the APF 40 of the Project 36. In the preferred embodiment of the invention, these Descriptions 54 are written in Extended Mark-Up Language (“XML”).

Function

Programming a controller algorithm begins when a User initiates a session by utilizing the User Interface 22 to access the Browser 20 of the Client 16 (FIG. 1). A request to initiate a connection is sent from the Client 16 to the Central Server 12. The Remoting Server 24 establishes the desired connection and maintains a communications channel between the Client 16 and the Central Server 12.

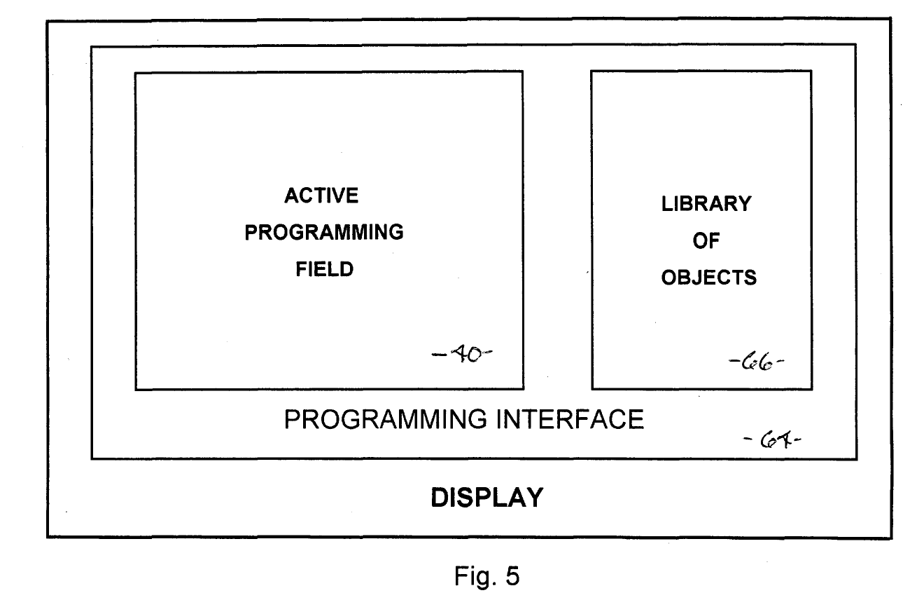

Once the communications channel has been established, the Remoting Server 24 transmits an XML file containing a Programming Interface 64 and a Library of Objects (“Library”) 66, as shown in FIG. 5. The Programming Interface 64, including the APF 40, and Library 66 are imposed on the Display 18, allowing a User to interact with the Programming Interface 64 through the User Interface 22 of the Client 16. The User then utilizes the Programming Interface 64 to request a new Project. This request is packaged as an XML file and transmitted to the Central Server 12 as an Action.

Once an Action has been received by the Remoting Server 24 (FIG. 2), the associated XML file is examined by the XML Debugger 26 to verify that the Action is valid. Once validity has been determined, a Project File 36 (FIG. 3), with its associated Project, is created and maintained on the Central Server 12.

Utilizing the User Interface, a User can select a Graphical Icon (“Icon”) representative of an Object 42 and move it to the APF 40. Once an Object's Icon has been placed within the APF, its Coordinates 60 (FIG. 4) are updated in the Programming Interface 64. An Icon's placement may be constrained by limitations on allowable horizontal and vertical coordinates referred to as a “snap-to” grid, or, alternatively, may be placed at any valid set of coordinates. Selection and placement of an Icon onto the APF 40 constitutes an Action. This and all subsequent actions are packaged as XML files and translated to the Central Server 12, received by the Remoting Server 24, and verified by the XML Debugger 26.

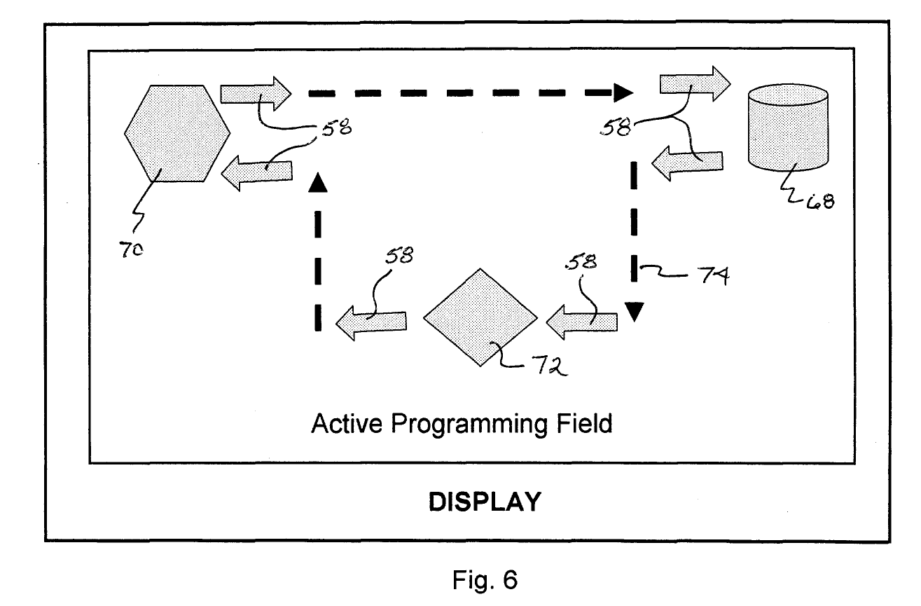

The Active Programming Field 40 is illustrated in FIG. 6. A first Icon 68 representing an Object 42 is initially placed within the APF. Additional Icons 70, 72 representing additional Objects 42 are selected from the Library 66 and placed within the APF 40. Each Object's Inputs/Outputs 58 are represented on its respective Icon 68,70,72. Traces 74, representative of electrical or communications paths, are then drawn between the Inputs/Outputs 58 of the disparate Icons 68,70,72. Each placement of an Icon 68,70,72 and each drawing of a Trace 74 creates a new Action which is transmitted to the Central Server 12, resulting in an update to the corresponding Project. In this manner, a User can create an algorithm for a controller or controller assembly by utilizing programming tools located on the Central Server 12.

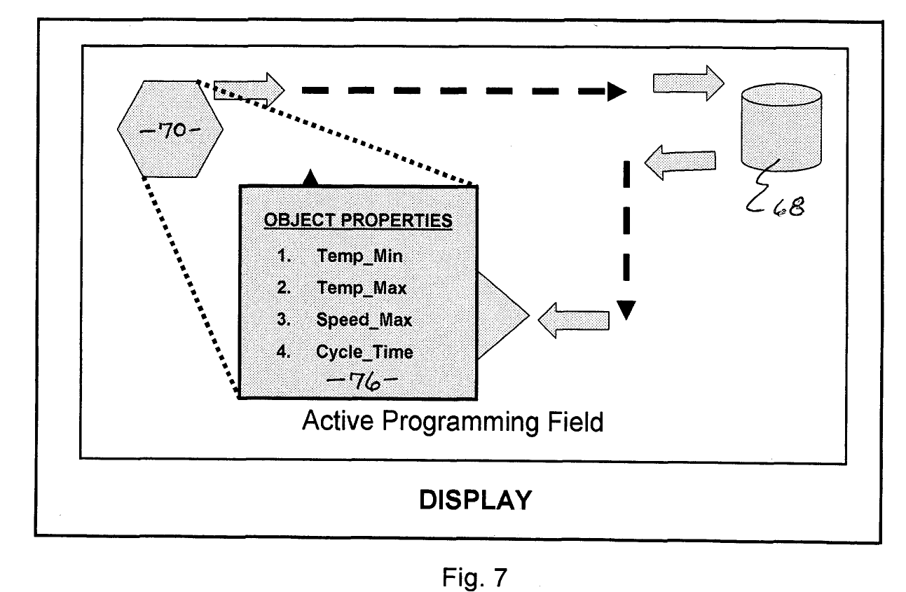

In the preferred embodiment of the invention, Icons 68,70,72 representative of Objects 42 may be selected by a User in a manner that displays a Dialog Box 76, as shown in FIG. 7. The Dialog Box 76 is a list or menu of Object Properties 56 which can be configured by the User, creating yet another Action to be transmitted to the Central Server 12.

In the preferred embodiment of the invention, multiple User may access the same Project from multiple Clients 16. Actions generated by a User results in changes to the Project, located on the Central Server 12. These changes are then packaged as XML files and transmitted to all other Clients 16 which are accessing the same Project.

Another aspect of the invention is that Users may temporary discontinue working on a Project and return to it later. In the preferred embodiment of the invention, the User can later access the Project from any Client 16 connected to the Central Server 12.

Once a Project is complete, the User issues a request to translate the Project into programming language code. In the preferred embodiment of the invention, the XML Translator converts the XML file representing the Project into “C” code. The resulting “C” code is then compiled into machine code by the C Compiler. It is this machine code which is utilized to control the functionality of the target controller or controller assembly.

In the preferred embodiment of the invention, the target Controller 14 or Controller Assembly 15 is attached to the Central Server 12 by the Internet, an Intranet, or an LAN (FIG. 1)or any combination of these. In this case, the User, utilizing a Client 16, can request that the resulting machine code be transmitted from the Central Server 12 to the Controller 80 or Controller Assembly 82.

Another aspect of the invention is that the Graphical Programming System may be utilized as a simulator, to test different combinations and characteristics of Elements 44, Functions 46, or Connections 48 (FIG. 3). Objects 42 can be utilized to represent real-world devices such as switches, relays, and motors, or may by used to simulate functions and concepts such as mathematical equations in a manner that simulates real-world processes. Once a Project has been constructed, a User may request a Simulation of either part or all of the Project. This Simulation Request is transmitted as an Action, and the actual simulation occurs on the Central Server 12. During simulation, the compiler generates code targeted for the processor of the Central Server. Alternatively, machine code may be generated for the processor of the Client, with an executable file being transmitted from the Central Server to the Client. The User can then run the executable file to observe the results of the simulation.

Others skilled in the art of making distributed control systems may develop other embodiments of the present invention. The embodiments described herein are but a few of the modes of the invention. Therefore, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A Graphical Programming System, comprising:
a Central Server including Programming Tools for development of programs, said programs being designed to operate Controllers or Controller Assemblies;
a Client including a User Interface, a Display, and an Internet Browser; and
a Communications Network for connecting said Central Server to said Client.

2. The Graphical Programming System of claim 1, further comprising a Controller, said Controller being connected to said Central Server by said Communications Network.

3. The Graphical Programming System of claim 1, further comprising a Controller Assembly, said Controller Assembly being connected to said Central Server by said Communications Network.

4. The Graphical Programming System of claim 1, whereby said Central Server comprises a Remoting Server for establishing and maintaining a communications channel with said Client.

5. The Graphical Programming System of claim 1, further comprising an XML Debugger for determining validity of Action Requests received from said Client.

6. The Graphical Programming System of claim 1, further comprising:
a Remoting Server for establishing and maintaining a communications channel with said Client; and
an XML Debugger for determining validity of Action Requests received from said Client;
wherein said Program Tools implement said Action Requests to create or modify a Project, said Project residing on said Central Server.

7. The Graphical Programming System of claim 6, wherein said Central Server transmits a Programming Interface to said Client, said Programming Interface including an Active Programming Field and a Library of Objects.

8. The Graphical Programming System of claim 7, wherein said Library of Objects includes one or more Objects, said Objects representing Elements, Actions, or Connections.

9. The Graphical Programming System of claim 8, wherein said Objects are represented by Graphical Icons on said Display.

10. The Graphical Programming System of claim 9, wherein said Active Programming Field is displayed on said Display, and said Graphical Icons may be selected by a User and placed within said Active Programming Field.

11. The Graphical Programming System of claim 10, wherein said Graphical Icons include graphical representations of respective Object's Inputs/Outputs, and said Inputs/Outputs are capable of being connected with Traces.

12. The Graphical Programming System of claim 11, wherein said Traces are representations of electrical connections.

13. The Graphical Programming System of claim 11, wherein said Traces are representative of communications channels.

14. The Graphical Programming System of claim 11, wherein said Graphical Icons are capable of being selected by a User to display Object Properties.

15. The Graphical Programming System of claim 14, further comprising a Translator, said Translator being utilized to convert said Project into Programming Language Instructions.

16. The Graphical Programming System of claim 15, further comprising a Compiler, said Compiler being utilized to convert said Programming Language Instructions into Executable Instructions.

17. The Graphical Programming System of claim 16, wherein said Executable Instructions are targeted to a specific Processor, said Processor being a component of a Controller.

18. The Graphical Programming System of claim 16, further comprising a Controller, said Controller being connected to said Central Server by said Communications Network.

19. The Graphical Programming System of claim 17, wherein a Plurality of Users utilizing a Plurality of Clients access said Central Server simultaneously and have concurrent access to said Project.

20. The Graphical Programming System of claim 19, wherein any Action Request generated by a User resulting in modification of the Project by said Programming Tools results in updating all Active Programming Fields displayed on said Displays of said Plurality of Clients.

21. The Graphical Programming System of claim 18, wherein said Executable Instructions are transmitted from said Central Server to said Controller over said Communications Network.

22. The Graphical Programming System of claim 11, wherein said Traces are representative of logical connections.

23. The Graphical Programming System of claim 16, wherein said Graphical Programming System is utilized as a simulator.

24. The Graphical Programming System of claim 23, wherein said simulator utilizes a processor of said Central Server to execute a simulation.

25. The Graphical Programming System of claim 23, wherein said simulator utilizes a processor of said Client to execute a simulation.
